(19) United States
(12) Patent Application Publication
(10) Pub. No.: US 2005/0271133 A1
(43) Pub. Date: Dec. 8, 2005

(54) Apparatus and methods for adaptation of signal detection threshold in a wireless local area network device in accordance with measured noise power

(75) Inventor: Shai Waxman, Haifa (IL)

Correspondence Address: EITAN, PEARL, LATZER & COHEN ZEDEK LLP, 10 ROCKEFELLER PLAZA, SUITE 1001, NEW YORK, NY, 10020, US

(73) Assignee: Intel Corporation

(21) Appl. No.: 10/857,847

(22) Filed: Jun. 2, 2004

(51) Int. Cl. H04Q 1/20

(52) U.S. Cl. 375/227

(57) ABSTRACT

A wireless local area network device includes a receiver formed, at least in part, by a radio frequency front-end and a processor having a physical layer controller. The processor is to estimate a noise power in the receiver independent of whether the receiver is receiving a communication signal according to a communication standard, and to adaptively adjust an active energy detection threshold of the receiver to be higher than an energy of noise having the noise power. The processor may also adjust an effective energy detection threshold of the physical layer controller.

### BACKGROUND OF THE INVENTION

A wireless local area network (WLAN) may be based on a cellular architecture where the system is subdivided into cells. One type of cell, known as a basic service set (BSS), contains stations controlled by an access point (AP), and another type of cell, known as an independent basic service set (IBSS), contains stations which are not controlled by an AP. A non-exhaustive list of such stations includes WLAN routers, WLAN-enabled notebook or laptop computers, WLAN-enabled desktop computers, WLAN-enabled personal digital assistants (PDA), WLAN-enabled cellular phones, WLAN-enabled appliances, and the like. In a BSS, stations may communicate with the AP over respective communication channels. In an IBSS, stations may communicate directly with other stations over communication channels. The access points of different BSSs may be connected via a distribution system (DS). The entire interconnected WLAN including the different cells, their respective access points and the distribution system may be known as an extended service set (ESS).

A BSS or IBSS may conform to a communication standard, such as, for example, ANSI/IEEE standard 802.11 for WLAN Medium Access Control (MAC) and Physical layer (PHY) specifications Rev. a for Higher-speed physical layer extension in the 5 gigaHertz (GHz) band, published 1999, and may use communication links, defined by at least their carrier frequencies and their spectral mask.

Noise generated and/or gathered in a receiver of such a WLAN device may affect the ability of the WLAN device in the BSS to recognize signals originated from other WLAN devices, to establish communication links among them and to maintain those communication links.

### BRIEF DESCRIPTION OF THE DRAWINGS

Embodiments of the invention are illustrated by way of example and not limitation in the figures of the accompanying drawings, in which like reference numerals indicate corresponding, analogous or similar elements, and in which:

FIG. 1 is a simplified block-diagram illustration of an exemplary wireless communication system, in accordance with some embodiments of the invention; and

FIG. 2 is a simplified flowchart illustration of an exemplary method for dynamic adaptation of active energy detection threshold of a receiver in a WLAN station, according to some embodiments of the invention.

It will be appreciated that for simplicity and clarity of illustration, elements shown in the figures have not necessarily been drawn to scale. For example, the dimensions of some of the elements may be exaggerated relative to other elements for clarity.

### DETAILED DESCRIPTION OF EMBODIMENTS OF THE INVENTION

In the following detailed description, numerous specific details are set forth in order to provide a thorough understanding of embodiments of the invention. However it will be understood by those of ordinary skill in the art that the embodiments of the invention may be practiced without these specific details. In other instances, well-known methods, procedures, devices and circuits have not been described in detail so as not to obscure the embodiments of the invention.

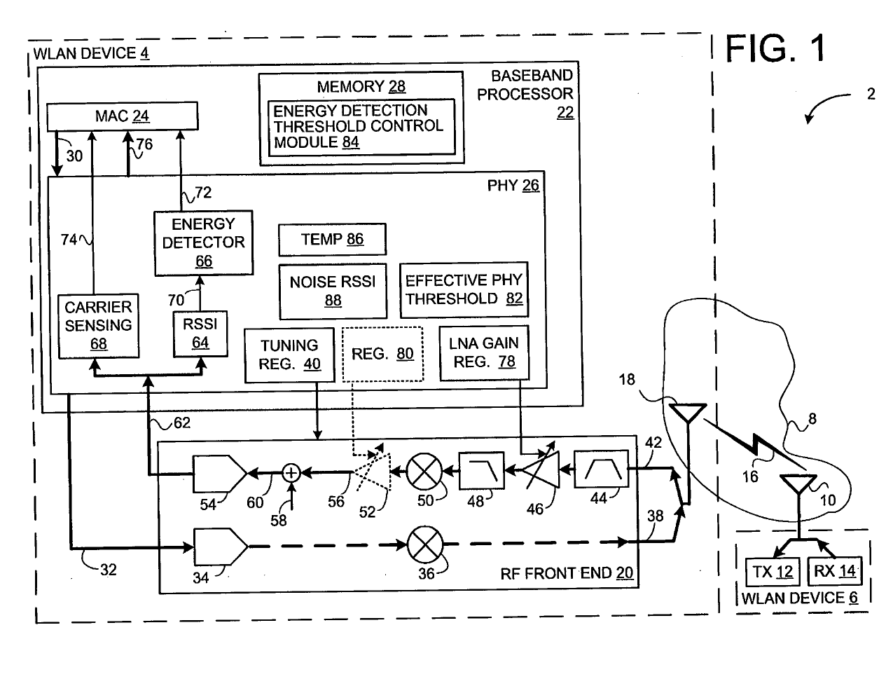

FIG. 1 is a simplified block-diagram illustration of an exemplary wireless communication system 2, in accordance with some embodiments of the invention. Wireless communication system 2 may include a wireless local area network (WLAN) device 4 and a WLAN device 6. WLAN device 4 may be, for example, a station, and WLAN device 6 may be, for example, an access point (AP).

WLAN device 4 and 6 may meet the following standards and/or other existing or future related standards, although this is a non-exhaustive list:
ANSI/IEEE standard 802.11 for Wireless LAN Medium Access Control (MAC) and Physical layer (PHY) specifications:
   Rev. a for Higher-speed physical layer extension in the 5 gigaHertz (GHz) band, published 1999,
   Rev. b for Higher-speed physical layer extension in the 2.4 GHz band, published 1999,
   Rev. g for Higher data rate extension in the 2.4 GHz band, published 2003.

WLAN device 4 and 6 may be suitable to communicate with one another over a wireless medium 8 in accordance with a particular WLAN standard, such as, for example, ANSI/IEEE standard 802.11 Rev. a (“802.11a”). Although the following description refers to definitions of 802.11a, it will be obvious to those skilled in the art how to modify the following for other WLAN standards.

Standards for WLAN may define several alternative communication channels to be used by WLAN devices to communicate with one other. 802.11a, for example, defines twelve communication channels having carrier frequencies in the 5 GHz Federal Communication Commission (FCC) defined Industrial, Scientific and Medical (ISM) band.

WLAN device 6 may include one or more antennae 10, and may include a transmitter (Tx) 12 and a receiver (Rx) 14, both coupled to antennae 10. WLAN device 6 may be able to transmit a communication signal 16, compliant with 802.11a, into wireless medium 8, and to receive signals from wireless medium 8.

WLAN device 4 may include one or more antennae 18, a radio frequency (RF) front-end 20 coupled to antennae 18, and a baseband processor 22 coupled to RF front-end 20. Baseband processor 22 may include a medium access controller (MAC) 24, a physical layer controller (PHY) 26, and a memory 28.

Baseband processor 22 and RF front-end 20 may form, at least in part, a transmitter-receiver (transceiver) through which WLAN device 4 may be able to transmit signals compliant with 802.11a into wireless medium 8, and may be capable of receiving signals from wireless medium 8.

For example, PHY 26 may receive communication frames 30 from MAC 24 and may send respective digital signals 32 to a digital-to-analog converter (DTA) 34. DTA 34 may convert digital signals 32 into respective analog signals that may be up-converted to an RF frequency by an up-converter 36, and may be sent to antennae 18 via conductors 38. The analog signals generated by DTA 34 may be filtered, shaped, amplified, conditioned and/or attenuated, for example, before being transmitted by antennae 18.

PHY 26 may be able to tune RF front-end 20 to selected communication channels according to the content of a tuning register 40. While RF front-end 20 is tuned to a selected one of the communication channels, signals transmitted by antenna 18 may have a carrier frequency substantially equal to the carrier frequency defined for the selected communication channel in the 802.11a specifications.

Antennae 18 may receive communication signal 16 from wireless medium 8, and may forward a replication of communication signal 16 to RF front-end 20 over, for example, one or more conductors 42. RF front-end 20 may contain, for example, a band-pass filter 44, a low noise amplifier (LNA) 46, a low-pass filter 48, a down-converter 50, an optional variable gain amplifier 52 and an analog-to-digital converter (ATD) 54. Other configurations of RF front-end 20 are possible.

A replication of communication signal 16 received over conductors 42 may be filtered by band-pass filter 44, amplified by LNA 46 and filtered again, by low-pass filter 48. Down-converter 50 may include one or more down-converting stages, and may down convert signals received from low-pass filter 48 into a baseband frequency, optionally, by first down converting the signals into an intermediate frequency and then down converting the intermediate frequency signals into the baseband frequency. The output signals of down-converter 50 may optionally be amplified by optional variable gain amplifier 52 to generate signals 56. While RF front-end 20 is tuned to a selected one of the communication channels, signals 56 may originate from communication signal 16 having frequencies in a predetermined frequency band around the carrier frequency defined for the selected communication channel in the 802.11a specifications.

A front end noise 58 may exist in RF front-end 20. RF front-end 20 may be partly generated by components of RF front-end 20 (including by ATD 54), and may be partly gathered by RF front-end 20 from the environment. A non-exhaustive list of examples of noise components of front end noise 58 includes additive white Gaussian noise (AWGN), shot noise, thermal noise, white noise, Johnson-Nyquist noise, One-over-F noise, background noise, non-linearity noise, quantization noise, and the like.

For clarity of the explanation, front end noise 58 is illustrated in FIG. 1 as an additive noise to signals 56, and signals 56 are described as purely originating from communication signal 16. However, it should be appreciated that noise components may be generated and/or added at any component or conductor in RF front-end 20. Moreover, noise components may not necessarily be additive, but may instead be accumulated in a non-additive way.

Signals 60 represent a combination of front-end noise 58 and signals 56. ATD 54 may receive signals 60 and may generate a digital output 62 of RF front-end 20.

If front-end noise 58 is substantially stronger than signals 56, digital output 62 may contain substantial information related to front-end noise 58 and may contain almost no information related to signals 56. Similarly, if signals 56 are substantially stronger than front-end noise 58, digital output 62 may contain substantial information related to signals 56 and may contain almost no information related to front-end noise 58. Moreover, if front-end noise 58 and signals 56 are of substantially similar magnitudes, digital output 62 may contain information on both.

PHY 26 may include a Received Signal Strength Indication (RSSI) module 64, an energy detector module 66 and a carrier sensing module 68. RSSI module 64, energy detector module 66 and carrier sensing module 68 may each independently be a software module, a hardware module or a hybrid software-hardware module.

25 RSSI module 64 may receive samples of digital output 62, may calculate powers of the samples and may output a RSSI 70 that may indicate the powers of the samples. Energy detector module 66 may receive RSSI 70 and may extract the energy of the samples from RSSI 70 and possibly other input (not shown). If the energy level of signals 60 is higher than the active energy detection threshold of WLAN 4, energy detector module 66 may assert a channel-busy indication 72 to MAC 24.

Carrier sensing module 68 may receive digital output 62 and may perform operations, such as, for example, correlations, on digital output 62 in order to sense whether digital output 62 contains 802.11a-compatible carrier information. If carrier sensing module 68 senses 802.11a-compatible carrier information in digital output 62, carrier sensing module 68 may assert a carrier-sense indication 74 to MAC 24.

If both channel-busy indication 72 and carrier-sense indication 74 are asserted, PHY 26 may extract extracted-information 76 from digital output 62 and may send extracted-information 76 to MAC 24. MAC 24 may recognize that both channel-busy indication 72 and carrier-sense indication 74 are asserted, may sample extracted-information 76 and may demodulate communication frames from extracted-information 76.

LNA 46 may have several possible gains, for example, three possible gains, and PHY 26 may be able to select an active gain of LNA 46 according to the content of an LNA gain register 78. In addition, optional variable gain amplifier 52 may have several possible gains and PHY 26 may be able to select an active gain of optional variable gain amplifier 52 according to the content of an optional register 80. Moreover, PHY 26 may have an effective energy detection threshold, defined by an effective PHY detection threshold register 82.

An active energy detection threshold of WLAN device 4 may be defined, at least in part, by the gains of LNA 46 and optional variable gain amplifier 52, and by the effective energy detection threshold of PHY 26.

For example, the three exemplary possible gains of LNA 46 may correspond to active energy detection thresholds of, for example, −90 dB, −80 dB and −70 dB. Optional variable gain amplifier 52 may have selectable gains in a range of, for example, 0 dB to 5 dB, and an effective energy detection threshold of PHY 26 may be set in a fine granularity in a range of, for example, 0 dB to +12 dB. Consequently, by setting values of LNA gain register 78, optional register 80 and effective PHY detection threshold register 82, PHY 32 may set the active energy detection threshold of WLAN device 4 to values in a range of −95 dB to −63 dB.

WLAN device 6 may transmit communication signal 16 at a selected power from a set of available transmission powers available to WLAN device 6. In addition, the power of communication signal 16, as received by WLAN device 4, may vary according to the distance of WLAN device 6 from WLAN device 4 and according to parameters of wireless medium 8, such as, for example, conductivity, dielectric constant, losses, reflections, and the like.

In order for energy detector 66 to assert channel-busy indication 72 in response to a received communication signal 16, a necessary but not sufficient requirement may be that the active energy detection threshold of WLAN device 4 is lower than the energy of communication signal 16, as received. Consequently, generally speaking, the lower the active energy detection threshold of WLAN device 4, the lower the energy levels of received communication signal 16 that may trigger assertion of channel-busy indication 72.

However, if the active energy detection threshold of WLAN device 4 is lower than the energy of front end noise 58 (the “noise floor”), the energy of front-end noise 58 may trigger assertions of channel-busy indication 72, and as a result, channel-busy indication 72 may not reliably indicate energy levels of received communication signal 16. Assertion of channel-busy indication 72 due to energy of front-end noise 58 is referred to as a “false alarm”.

Front-end noise 58 may not have a constant energy. Its energy may vary according to properties of RF front-end 20, antenna 18 and other components of WLAN device 4. These properties may be affected by manufacturing tolerances, and may be prone to fluctuations due to, for example, changes in ambient temperature, temperature of components of RF front-end 20, and the tuned frequency of RF front-end 20.

Memory 28 may store an energy detection threshold control module 84 to be executed by PHY 26 for adapting the active energy detection threshold of WLAN device 4 in relation to estimations of the RSSI of front-end noise 58 (the “noise power”). Module 84 may use a parameter MAX_NOISE_RSSI that may represent a predefined maximal noise power of front-end noise 58 and may be a constant or a programmable variable.

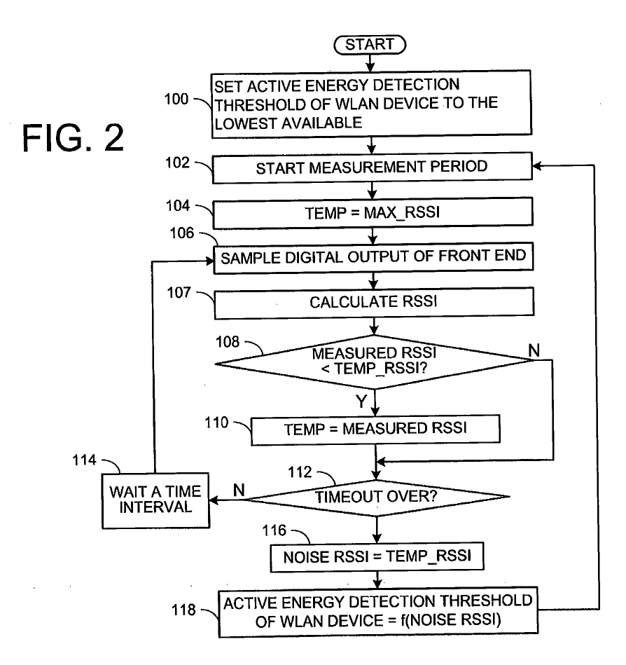

As shown in FIG. 2, at the beginning of the method, module 84 may set the active energy detection threshold of WLAN device 4 to the lowest energy detection threshold available (100), and may start a sampling period of duration in the range of, for example, 1 millisecond to one minute, for estimating the noise-power (102). Module 84 may store the parameter MAX_NOISE_RSSI in a temporary register 86 (104), may sample digital output 62 (106) and may activate RSSI module 64 to calculate the RSSI of the sample (107). If the calculated RSSI is less than the value stored in temporary register 86 (108), module 84 may store the calculated RSSI of signals 60 in temporary register 86 (110). If the sampling period is not over (112), module 84 may wait for a predetermined time interval (114) of, for example, 4 micro seconds, and may continue to box (106). Module 84 may continue executing the loop of boxes (106), (108), (110), (112) and (114) until the sampling period is over, may determine that the noise-power equals to the content of temporary register 86, and may store the content of temporary register 86 in a noise-RSSI register 88 (116).

The sampling period may have a duration that is longer than a duration of a longest permitted packet of communication signals according to a particular communication standard, such as, for example, 802.11a. The time intervals may be shorter than a shortest permitted gap between consecutive packets of communication signals according to the particular communication standard.

If at least one of the calculation results is less than MAX_NOISE_RSSI, the value stored in noise-RSSI register 88 at box (116) may represent the lowest calculated RSSI during the sampling period. According to standard 802.11a, WLAN 6 must embed predefined gaps between transmissions of consecutive packets. The sampling period may be long enough to contain at least one sample that occurs during such a gap, and therefore, the lowest calculated RSSI during the sampling period may actually be an estimation of the noise-power.

Module 84 may set the active energy detection threshold of WLAN device 4 according to a function of the noise-power (118) and may continue to box (102).

A non-exhaustive list of examples for antennae 10 and 18 includes dipole antennae, loop antennae, shot antennae, dual antennae, omni-directional antennae or any other suitable antennae.

A non-exhaustive list of examples for WLAN devices 4 and 6 includes a WLAN mobile unit, a WLAN stationary unit, a WLAN add-on card, a WLAN personal computer memory card international association (PCMCIA) card, a WLAN personal computer (PC) card, a WLAN switch, a WLAN router, a WLAN server, a game console, a digital camera, a digital video camera, a television set, a desktop personal computer, a work station, a server computer, a laptop computer, a notebook computer, a hand-held computer, a personal digital assistant (PDA), and the like.

A non-exhaustive list of examples for baseband processor 22 includes a central processing unit (CPU), a digital signal processor (DSP), a reduced instruction set computer (RISC), a complex instruction set computer (CISC) and the like. Moreover, processor 22 may be part of an application specific integrated circuit (ASIC) or may be a part of an application specific standard product (ASSP).

A non-exhaustive list of examples for memory 28 includes any combination of the followings: registers, latches, read only memory (ROM), mask ROM, synchronous dynamic random access memory (SDRAM), static random access memory (SRAM), flash memory, and the like.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the spirit of the invention.

1. A method comprising:
estimating a noise power in a receiver of a wireless local area network device independent of whether said receiver is receiving a communication signal according to a communication standard; and
adjusting an active energy detection threshold of said receiver to be higher than an energy of noise having said noise power.

2. The method of claim 1, wherein estimating said noise power comprises:
generating samples of a digital output of a radio frequency front-end of said receiver at time intervals during a sampling period;
calculating powers of said samples; and
determining that said noise power is a lowest of said calculated powers,
wherein said sampling period has a duration that is longer than a duration of a longest permitted packet of communication signals according to said communication standard, and
wherein said time intervals are shorter than a shortest permitted gap between packets of communication signals according to said communication standard.

3. The method of claim 1, wherein adjusting said active energy detection threshold includes:
adjusting a gain of a low noise amplifier of said receiver.

4. The method of claim 1, further comprising:
adjusting an effective energy detection threshold of a physical layer controller of said receiver.

5. A method comprising:
estimating a noise power in a receiver of a wireless local area network device independent of whether said receiver is receiving a communication signal according to a communication standard, wherein estimating said noise power includes at least:
generating samples of a digital output of a radio frequency front-end of said receiver at time intervals during a sampling period;
calculating powers of said samples; and
determining that said noise power is a lowest of said calculated powers,
wherein said sampling period has a duration that is longer than a duration of a longest permitted packet of communication signals according to said communication standard, and wherein said time intervals are shorter than a shortest permitted gap between consecutive packets of communication signals according to said communication standard.

6. The method of claim 5, further comprising:
adjusting an active energy detection threshold of said receiver to be higher than an energy of noise having said noise power.

7. The method of claim 6, wherein adjusting said active energy detection threshold includes:
adjusting a gain of a low noise amplifier of said receiver.

8. The method of claim 6, further comprising:
adjusting an effective energy detection threshold of a physical layer controller of said receiver.

9. An article comprising a storage medium having stored thereon instructions that, when executed by a computing platform, result in:
estimating a noise power in a receiver of a wireless local area network device independent of whether said receiver is receiving a communication signal according to a communication standard; and
adjusting an active energy detection threshold of said receiver to be higher than an energy of noise having said noise power.

10. The article of claim 9, wherein executing said instructions further results in:
generating samples of a digital output of a radio frequency front-end of said receiver at time intervals during a sampling period;
calculating powers of said samples; and
determining that said noise power is a lowest of said calculated powers,
wherein said sampling period has a duration that is longer than a duration of a longest permitted packet of communication signals according to said communication standard, and
wherein said time intervals are shorter than a shortest permitted gap between packets of communication signals according to said communication standard.

11. The article of claim 9, wherein executing said instructions further results in:
adjusting an effective energy detection threshold of a physical layer controller of said receiver.

12. An article comprising a storage medium having stored thereon instructions that, when executed by a computing platform, result in:
estimating a noise power in a receiver of a wireless local area network device independent of whether said receiver is receiving a communication signal according to a communication standard, wherein estimating said noise power includes at least:
generating samples of a digital output of a radio frequency front-end of said receiver at time intervals during a sampling period;
calculating powers of said samples; and
determining that said noise power is a lowest of said calculated powers,
wherein said sampling period has a duration that is longer than a duration of a longest permitted packet of communication signals according to said communication standard, and wherein said time intervals are shorter than a shortest permitted gap between consecutive packets of communication signals according to said communication standard.

13. The article of claim 12, wherein executing said instructions further results in:
adjusting an active energy detection threshold of said receiver to be higher than an energy of noise having said noise power.

14. The article of claim 12, wherein executing said instructions further results in:
adjusting an effective energy detection threshold of a physical layer controller of said receiver.

15. A wireless local area network device comprising:
a receiver including at least:
a radio frequency front-end; and
a processor having a physical layer controller,
wherein said processor is to estimate a noise power in said receiver independent of whether said receiver is receiving a communication signal according to a communication standard, and to adjust an active energy detection threshold of said receiver to be higher than an energy of noise having said noise power.

16. The wireless local area network device of claim 15, wherein said front-end includes a low noise amplifier, and said processor is to adjust said active energy detection threshold at least in part by adjusting a gain of said low noise amplifier.

17. The wireless local area network device of claim 15, wherein said front-end has a digital output, and said processor is to generate samples of said digital output at time intervals during a sampling period, to calculate powers of said samples, and to determine that said noise power is a lowest of said calculated powers, wherein said sampling period has a duration that is longer than a duration of a longest permitted packet of communication signals according to said communication standard, and wherein said time intervals are shorter than a shortest permitted gap between packets of communication signals according to said communication standard.

18. The wireless local area network device of claim 15, wherein said wireless local area network device is a station.

19. The wireless local area network device of claim 15, wherein said wireless local area network device is an access point.

20. The wireless local area network device of claim 15, further comprising:
a dipole antenna coupled to said front-end.

21. A wireless local area network system comprising:
a first wireless local area network device; and
a second wireless local area network device comprising:
a receiver including at least:
a radio frequency front-end; and
a processor having a physical layer controller,
wherein said processor is to estimate a noise power in said receiver independent of whether said receiver is receiving a communication signal according to a communication standard, and to adjust an active energy detection threshold of said receiver to be higher than an energy of noise having said noise power.

22. The wireless local area network system of claim 21, wherein said front-end includes a low noise amplifier, and said processor is to adjust said active energy detection threshold at least in part by adjusting a gain of said low noise amplifier.

23. The wireless local area network system of claim 21, wherein said front-end has a digital output, and said processor is to generate samples of said digital output at time intervals during a sampling period, to calculate powers of said samples, and to determine that said noise power is a lowest of said calculated powers, wherein said sampling period has a duration that is longer than a duration of a longest permitted packet of communication signals according to said communication standard, and wherein said time intervals are shorter than a shortest permitted gap between packets of communication signals according to said communication standard.

24. The wireless local area network system of claim 21, wherein said second wireless local area network device is a station.

25. The wireless local area network system of claim 21, wherein said second wireless local area network device is an access point.
